(19) United States
(12) Patent Application Publication
(10) Pub. No.: US 2015/0238382 A1
(43) Pub. Date: Aug. 27, 2015

(54) ROBOT FOR WALKING REHABILITATION THERAPY OF STROKE PATIENT

(71) Applicant: KOREA INSTITUTE OF INDUSTRIAL TECHNOLOGY, Chungcheongnam-do (KR)

(72) Inventors: Hyun Sub Park, Gyeonggi-do (KR); In Hoon Jang, Gyeonggi-do (KR); Jun Young Jung, Gyeonggi-do (KR); Hyun Dae Yang, Gyeonggi-do (KR); Chul Je Park, Gyeonggi-do (KR); Min Gi Chae, Busan (KR)

(73) Assignee: KOREA INSTITUTE OF INDUSTRIAL TECHNOLOGY, Chungcheongnam-do (KR)

(21) Appl. No.: 14/437,780

(22) PCT Filed: Aug. 6, 2013
(86) PCT No.: PCT/KR2013/007071

§ 371 Date: Apr. 22, 2015

(30) Foreign Application Priority Data
Oct. 22, 2012 (KR) 10-2012-0117259

(51) Int. Cl. A61H 3/04; A61H 3/00

(52) U.S. Cl. CPC A61H 3/04; A61H 3/00; A61H 2205/10

(57) ABSTRACT

A robot for rehabilitation therapy includes a robot body and a walker. The robot body includes a fixing band for supporting a waist of a patient, pelvic joint shafts rotatably connected to the fixing band, first arms extending downward from the pelvic joint shafts, first connecting joint shafts connected to the first arm, second arms extending downward from the first connecting joint shafts, second connecting joint shafts rotatably connected to the second arms, extension pieces extending downward from the second connecting joint shafts, and footboards rotatably connected to the extension pieces by ankle joint shafts. The walker includes an upper frame, a connection frame, and a wheeled lower frame. The angles of the first arms and the second arms are adjusted according to the length of the lower half of the body of the patient.

### CROSS REFERENCE TO RELATED APPLICATIONS

This application is a National Stage patent application of PCT International Patent Application No. PCT/KR2013/007071 (filed on Aug. 6, 2013) under 35 U.S.C. §371, which claims priority to Korean Patent Application No. 10-2012-0117259 (filed on Oct. 22, 2012), the teachings of which are incorporated herein in their entireties by reference.

### TECHNICAL FIELD

The present disclosure relates, in general, to a robot for walking rehabilitation of patients such as stroke patients and, more particularly, to a robot which is easily worn by the patients, irrespective of their body types, and thus quickly operated for walking rehabilitation therapy of the patients, thereby saving on the time and costs for the walking rehabilitation therapy.

### BACKGROUND ART

Generally, persons who have suffered strokes, or spinal injuries by traffic accidents, have gait disturbance. If they have also suffered from arthritis, most of them are not even able to stand up straight. Particularly, the old or long-stay patients had a lot of pain in walking using their hip joints and knee joints because of the loss of their muscle strengths.

Such persons who had gait disturbance need walking rehabilitation to force them to walk in order to activate their legs' nerves while increasing their muscle strengths.

To this end, a walker has been currently widely used as a rehabilitating means.

Such a walker has a wheeled frame body which is held by difficult-to-walk persons standing with their hands so as to support the persons' bodies, whereby the persons walk step by step, pushing the walker forwards in a state of supporting their bodies thereto.

Additionally, such difficult-to-walk persons lying in bed can be treated with massage therapy by a physical therapist so that the legs are manually stretched and bent in a repeated manner.

However, using the walker has problems in that patients use up a lot of physical energy, along with having a lot of stress, during walking, since patients have to walk while directly holding a grip of the walker.

Further, using the massage therapy by physical therapist has problems in that, since the rehab exercise is not conducted by the patients themselves, the efficiency of rehabilitation therapy is degraded, and in that, since at least one physical therapist is required to perform such rehabilitation therapy, rehabilitation costs are increased.

To solve these problems, a rehabilitation robot has been developed, which is worn by a patent at his/her lower body so that the legs of the patient can be moved along with the automatic motion of the robot. However, since most of rehabilitation robots perform the rehabilitation operation while the patient is fastened at his/her waist, pelvis, knee, and ankle in the lower body, there are problems of prolonged preparation stage. Further, another problem arises in that the designing and manufacturing costs are increased so that many persons cannot use such rehabilitation service, since the rehabilitation robot should be designed to exactly suit the body type of the patient.

### DISCLOSURE

### Technical Problem

Accordingly, the present disclosure has been made keeping in mind the above problems occurring in the prior art, and an object of the present disclosure is to provide a robot which is easily worn by stroke patients, irrespective of their body types, and thus quickly operated for walking rehabilitation therapy of stoke patients, thereby saving on the time and costs for the walking rehabilitation therapy.

### Technical Solution

In order to accomplish the above object(s), at least one embodiment of the present invention provides a robot for walking rehabilitation therapy of a patient (e.g., a stroke patient), including: a robot body including a fixing band for supporting a waist of the patient, pelvic joint shafts which are rotatably connected to the fixing band, first arms which extend downward to a specified length from the pelvic joint shafts, first connecting joint shafts which are connected to the first arms, second arms which extend downward from the first connecting joint shafts, second connecting joint shafts which are rotatably connected to the second arms, extension pieces which extend downward from the second connecting joint shafts, and footboards, which are rotatably connected to the extension pieces by ankle joint shafts, for fixing and supporting the patient's feet; and a walker including an upper frame for supporting a fixing band-side of the robot body, a connection frame for supporting the upper frame, and a lower frame which is connected to the connecting frame and includes a plurality of wheels, wherein the angles of the first arms and the second arms are adjusted according to the length of the lower half of the body of the patient.

The footboards may always maintain vertical positions relative to the ground, irrespective of a change in angles of the first and second arms.

The fixing band may further include a waist-support.

The waist-support may include a distance-adjuster for adjusting the length of the width of the waist-support.

The robot may further include a safety unit interconnected between the fixing band and the upper frame to prevent the patient from being disengaged from the walker.

The safety unit may be at least one of a wire and a flexible cable.

### Advantageous Effects

According to the present disclosure, the robot can be easily worn by patients (e.g., stroke patients), irrespective of their body types, and thus quickly operated for walking rehabilitation therapy of the patients, thereby saving on the time and costs for the walking rehabilitation therapy.

### BRIEF DESCRIPTION OF THE DRAWINGS

FIG. 1 is a robot for walking rehabilitation therapy of stroke patients according to at least one embodiment of the present invention;

FIG. 2 is a side view of the robot of FIG. 1;

FIG. 3 is a rear view of the robot of FIG. 1; and

FIGS. 4 and 5 are views showing the operation of the robot for walking rehabilitation therapy of stroke patients according to at least one embodiment of the present invention.

### MODE FOR DISCLOSURE

Embodiments of the present invention will be described below in more detail with reference to the accompanying drawings. It should be understood that the following specific structural and functional descriptions are merely examples given for the purpose of providing a description of the exemplary embodiments according to the concept of the present invention. Accordingly, various variations may be performed on the exemplary embodiments of the present invention, and it should be understood that the scope and spirit of the present invention will not be limited only to the exemplary embodiments presented in the description of the present invention set forth herein.

The terms including expressions, such as first and/or second, used in the specification of the present invention may be used to describe various elements of the present invention. However, the elements of the present invention should not be limited by the terms used in the specification of the present invention. In other words, such terms will be used only to differentiate one element from other elements of the present invention.

The terminology used in the specification of the present invention is for the purpose of describing particular embodiments only and is not intended to limit the invention. As used in the specification and the appended claims, the singular forms “a”, “an” and “the” are intended to include the plural forms as well, unless context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

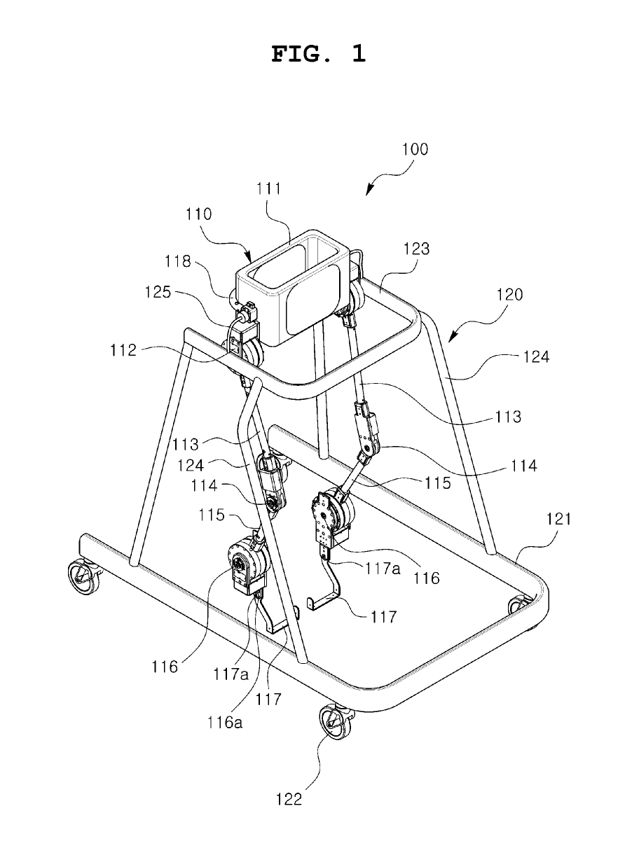

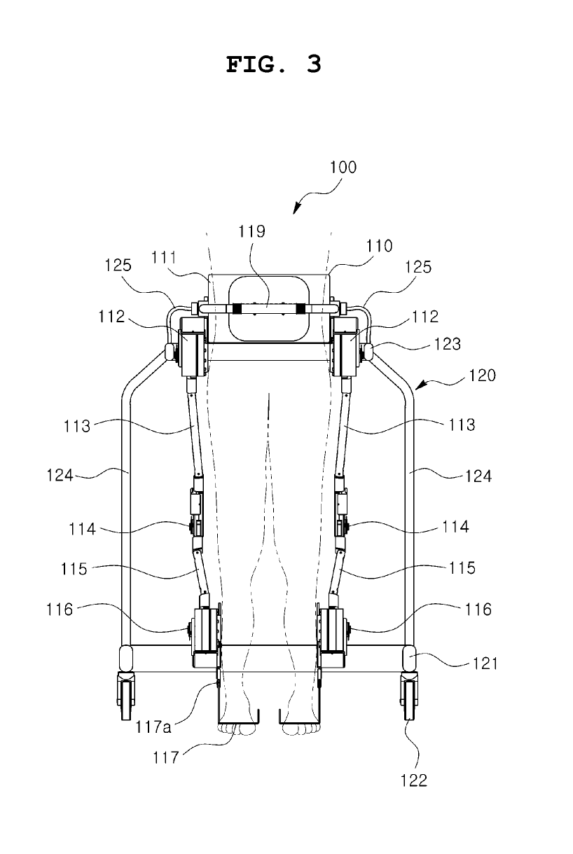

As shown in FIGS. 1 to 3, a robot 100 for walking rehabilitation therapy of a patient (e.g., a stroke patient), includes: a robot body 110, which includes a fixing band 111 for supporting a waist of the patient, pelvic joint shafts 112 which are rotatably connected to the fixing band 111, first arms 113 which extend downward to a specified length from the pelvic joint shafts 112, first connecting joint shafts 114 which are connected to the first arms 113, second arms 115 which extend downward from the first connecting joint shafts 114, second connecting joint shafts 116 which are rotatably connected to the second arms 115, extension pieces 116a which extend downward from the second connecting joint shafts 116, and footboards 117, which are rotatably connected to the extension pieces 116a by ankle joint shafts 117, for fixing and supporting the patient's feet; and a walker 120, which includes an upper frame 123 for supporting a fixing band 111-side of the robot body 110, a connection frame 124 for supporting the upper frame 123, and a lower frame 121 which is connected to the connecting frame 124 and is provided with a plurality of wheels, wherein the angles of the first arms 113 and the second arms 115 are adjusted according to the length of the lower half of the body of the patient.

In the meantime, electronic torsion spring locks (not shown) are provided in the pelvic joint shafts 112 and the second connecting joint shafts 116, respectively. The first connecting joint shafts 114 and the ankle joint shafts 117a have a freely-rotatable structure, and the torsion spring locks serve to assist bending and stretching of the knee joint and prevent the feet from dragging on the ground during walking for natural walking.

The locks enable the pelvic joint shafts and the second connecting joint shafts to be locked by a brake so as to firmly support the body during a stance phase, and, during a swing phase, also enable them to be unlocked and able to bend at a normal knee angle similar to the knee angle at which the normal person can take during walking. Along with this, the locks assist the walking by stimulating knee joint muscles using an electric stimulator in order to obtain bending and stretching forces of the knee.

A safety unit 125 connects the fixing band 111 of the robot body 110 and the upper frame 123, wherein the safety unit may comprise a wire or a flexible cable. When a patient wears the robot body in a state of being fastened by the fixing band, he/she can freely move by up to the length of the safety unit within the walker, and when he/she is in danger of falling, the falling can be prevented by the safety unit supporting the patient.

The footboards 117 may preferably always maintain vertical positions relative to the ground, irrespective of a change in angles of the first and second arms 113 and 115. When an angle (θ) between the first and second arms 113 and 115 is changed to suit the height of a patient, the height H is correspondingly regulated. Thus, such a vertical position is provided for naturally changing the position of the footboards according to the changed angle.

The fixing band 111 is in the form of a belt having an amount of elasticity, and has a waist-support 118 at a rear side thereof, wherein the waist-support is provided at a middle portion thereof with a distance-adjuster 119 for adjusting the length of the width of the waist-support.

The distance-adjuster 119 is in the form of a tube. A diameter of which is larger than that of the waist-support 118, so that the waist-support is distance-adjusted in a state of being inserted into the distance-adjuster.

The ankle joint shafts 117a serve to maintain a vertical position relative to the ground via counter rotation by their own weights as the angle between the first and second arms 113 and 115 is changed according to the height of a patient. Further, the ankle joint shafts maintain vertical positions by their own weights in the same manner as mentioned above even when they are rotated according to the operation of the second connecting joint shafts 116.

Although not shown in the drawings, the ankle joint shafts 117a may be provided with springs for providing elasticity in the forward/rearward rotation direction.

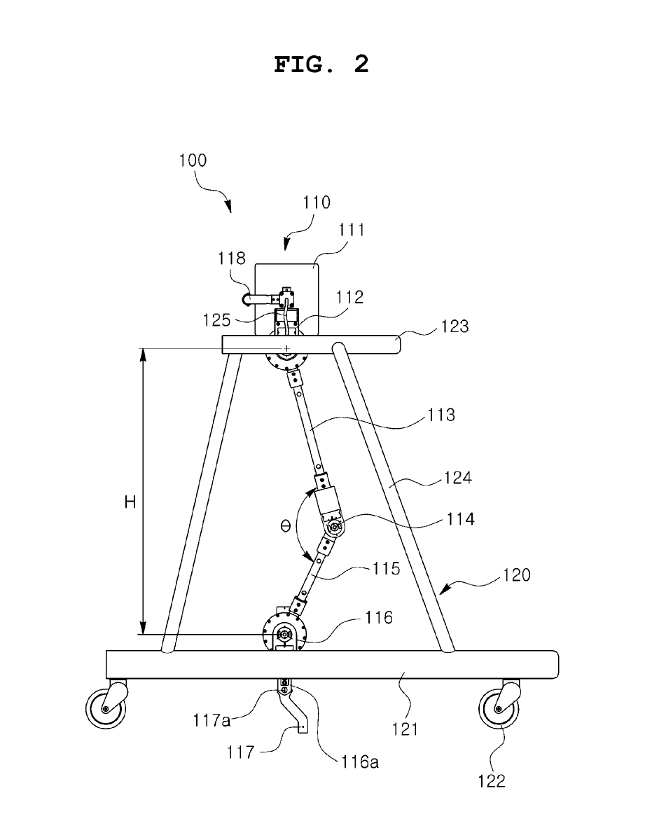

In the meantime, as shown in FIG. 2, an additional frame may be further installed to the other side of the connection frame 124, taking account of the weight of a patient.

The operation of at least one embodiment of the present invention will be described below with reference to the accompanying drawings.

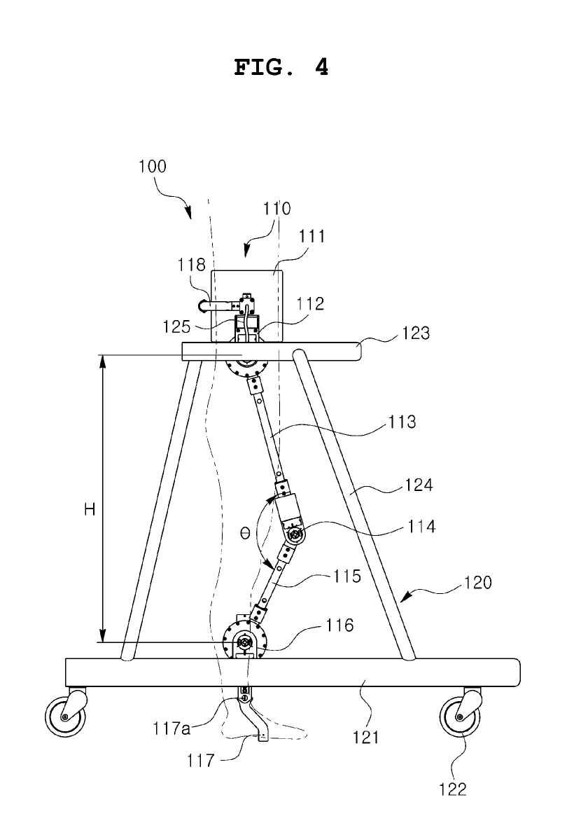

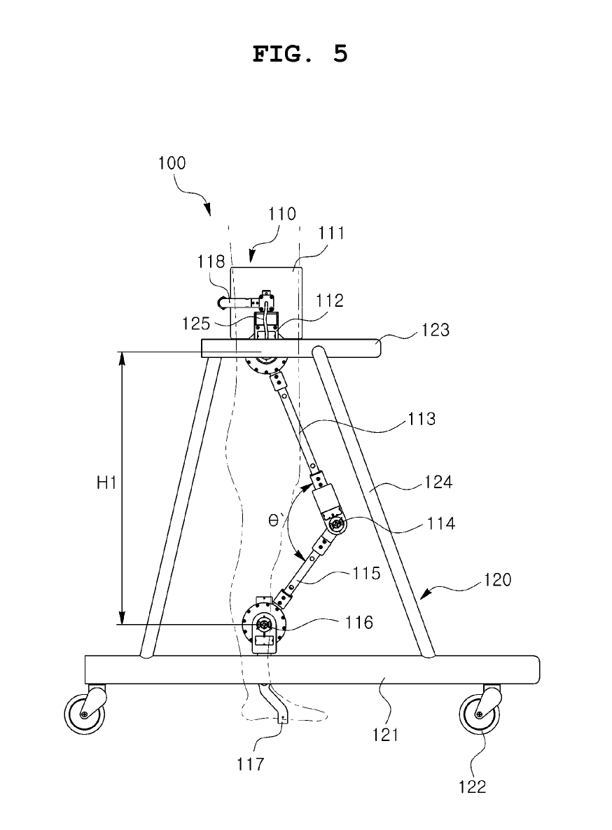

As shown in FIGS. 4 and 5, the waist of a patient is completely fixed by placing the fixing band 111 therearound, and then is supported by adjusting the width of the waist-support 118.

In this state, the feet of the patient are placed on the footboards 117 and completely fixed together with the footboards 117 using the a band (not shown).

Herein, the angle between the first and second arms 113 and 115 is naturally adjusted according to the height of the patient, obtaining an angle to suit the lower body (a distance from the pelvic joint to the ankle) of the patient.

Then, when the patient performs walking action on the ground together with the footboard on which the patient steps, rehabilitation therapy is performed such that the angle between the first and second arms is reduced within the adjusted angle (θ1) according to the bent angle of the knees of the patient. Similarly, the pelvic joint shafts and the second connecting joint shafts are also operated to correspond to the motion of the patient.

Herein, the pelvic joint shafts and the second connecting joint shafts are driven with control signals of a controller, and the first connecting joint shafts and the ankle joint shafts are connected together only by shafts, thereby providing a natural rotation according to the motion of the patient.

Although the present embodiment has not illustrated the configuration about the motion control of the robot body, the pelvic joint shafts 112 and the second connecting joint shafts 116 can be operated by a separate controller, whereby the lower body of the patient can be naturally subjected to a rehabilitation exercise. Herein, the pelvic joint shafts 112 and the second connecting joint shafts 116 have the same configuration as those in a typical rehabilitation robot, and therefore a detailed description thereof will be omitted.

Further, as set forth from the foregoing, an initial height H from the pelvic joint shaft 112 to the second connecting joint shaft 116 can be regulated to the height H1 by the angle between the first and second arms 113 and 115 according to the height of the lower body of the patient.

That is, when the angle between the first and second arms 113 and 115 is regulated to suit the height of the patient who wears the robot body, the operation is performed within the angle regulated in the second connecting joint shafts 116, so that the elements are regulated so as not to enlarge the angle therebetween.

Then, if the robot is used by another patient, it can be reused by initializing the angle regulated by the controller.

While the controller has not been described in detail in the description, the controller may be adapted such that personal information of many patients is previously stored in the controller so that the controller can be quickly operated to adjust the height using pre-stored information of the patient.

Although a variety of embodiments have been described in the description, they are provided to assist in understanding the technical content of the present invention, so it is not intended that the technical scope of the present invention is limited thereto.

That is, those skilled in the art will appreciate that various modifications, additions and substitutions are possible, without departing from the scope and spirit of the invention as disclosed in the accompanying claims. Of course, it should be construed that such modifications, additions and substitutions are defined within the technical scope of the present invention.

1. A robot for walking rehabilitation therapy of a stroke patient, comprising:
a robot body including a fixing band for supporting a waist of the patient, pelvic joint shafts which are rotatably connected to the fixing band, first arms which extend downward to a specified length from the pelvic joint shafts, first connecting joint shafts which are connected to the first arms, second arms which extend downward from the first connecting joint shafts, second connecting joint shafts which are rotatably connected to the second arms, extension pieces which extend downward from the second connecting joint shafts, and footboards, which are rotatably connected to the extension pieces by ankle joint shafts, for fixing and supporting feet of the patient; and
a walker including an upper frame for supporting a fixing band-side of the robot body, a connection frame for supporting the upper frame, and a lower frame which is connected to the connecting frame and includes a plurality of wheels,
wherein the angles of the first arms and the second arms are adjusted according to the length of the lower half of the body of the patient.

2. The robot according to claim 1, wherein the pelvic joint shafts and the second connecting joint shafts include driving joints and the first connecting joint shafts and the ankle joint shafts include driven joints, so as to enable the patient to install the shafts irrespective of the length of the lower body of the patient.

3. The robot according to claim 1, further comprising a safety unit interconnected between the fixing band and the upper frame to prevent the patient from being disengaged from the walker.

4. The robot according to claim 3, wherein the safety unit is formed by at least one of a wire and a flexible cable.
